(19) United States
(12) Patent Application Publication
(10) Pub. No.: US 2022/0044592 A1
(43) Pub. Date: Feb. 10, 2022

(54) Scripor alphabet - method for representing colors for the visually impaired and blind people

(71) Applicant: SCRIPOR ALPHABET S.R.L., Cluj-Napoca, Cluj (RO)

(72) Inventor: Tudor Paul SCRIPOR, Cluj-Napoca, Cluj (RO)

(21) Appl. No.: 17/416,491

(22) PCT Filed: Dec. 17, 2019
(86) PCT No.: PCT/EP2019/000340

§ 371 Date: Jun. 20, 2021

(30) Foreign Application Priority Data
Dec. 21, 2018 (RO) A 2018 01134

(51) Int. Cl. G09B 21/00

(52) U.S. Cl. CPC G09B 21/004

(57) ABSTRACT

A method for color representation and recognition by blind or visually impaired persons that allows the recognition, differentiation and learning of colors in a tactile way by the blind, visually impaired and by the people who suffer from other affections or intellectual disabilities. There is a color matrix in tactile language for tactile color recognition which consists of 10 points, of which 9 points are arranged on three columns of three points and a point of orientation. The orientation point is located at the top, above the second column and will be ubiquitous for each color or shade. This method implies the using of a punch mark, like the one used to write the Braille Alphabet.

### FIELD OF THE INVENTION

This invention is generally related to the following fields: education, toy manufacturing, safety of sightless people, textile industry, information technology, arts (art galleries and museums), machines, vehicles, mechanics and mechatronics. More specifically, this invention is related to tactile recognition of the colors by the blind or visually impaired persons and facilitates the accessibility of the environment of the persons with disabilities, especially the blind through many ways. Stimulating creativity, early learning, education can be achieved through a very wide range of educational objects, games, coloring books, art albums, coloring/painting tools etc. The symbols created can be used in children's books, on toys and games. In matters of safety, the use of the symbols will also help to increase the quality of life by applying the red and green symbols to the pedestrian crossings.

More particularly, it also incorporates aspects of other fields like the textile industry, by applying the symbols on clothing labels, or in the making of software and hardware programs and equipment for accessibility, therapy and recovery for people with visual or intellectual disabilities and also printers, scanners, or the transposition of the great masterpieces in museums and art galleries using this tactile language of color.

### DESCRIPTION OF PRIOR ART

The accessibility of the environment and the improvement of the quality of life of persons with disabilities should be a priority in our society today.

So far, there is the well-known Braille Alphabet as a way of reading and using a tactile recognition of the letters and numbers for the blind or visually impaired. Nevertheless, there are major differences between this method (Scripor Alphabet) and the Braille Alphabet:

This method is made up of only 10 tactile-graphic elements while the Braille Alphabet contains 63 elements. The shades of the colors are composed by association, making it very easy to learn, starting with very young ages.

This method of representation is composed of a 10 points matrix, of which 9 points are arranged on 3 columns and the orientation point, while the Braille Alphabet is composed of a 6 points matrix with no orientation point.

This method can be read and recognized from left to right, vice versa, from bottom to top and vice versa while the Braille Alphabet is read from left to right only.

This method found the solution of the tactile-graphic representation of a color only through a symbol. It is universal, because its learning is not conditioned by the language, culture or geographical area. Colors can be easily recognized in any position, even in a painting, because there is the orientation point.

Considering the prior art that we are aware of (JPH10309860—Method for representing character or symbol by color arrangement) and the Braille Alphabet, the novelty from the technical point of view is that Scripor Alphabet, the present invention, has totally different features. The invention has a single 10 points matrix including the orientation point. Every shade and color can be read by using only this matrix. Also, considering all the above mentions, Scripor Alphabet meets the novelty requirements.

### SUMMARY OF THE INVENTION

This method of representation is also called the alphabet of colors for the blind, its reading is made with the fingers, from right to left, or from left to right, from top to bottom and vice versa. The invention is called the Scripor Alphabet by the name of the inventor. The writing of this alphabet will be done with the help of a punch mark, like the one used to write the Braille Alphabet.

This method is composed of a color matrix created in tactile language (FIG. 1, FIG. 2 and FIG. 3). The color alphabet matrix consists of 10 points, from which 9 points are arranged on three columns by three points and a point of orientation located above the second column, with the following notation (FIG. 1):

Point 1 on the top left, row 1, column 1;
Point 2 in the middle left, row 2 column 1;
Point 3 in the lower left, row 3 column 1;
Point 4 in the upper center, row 1 column 2;
Point 5 in the middle center, row 2 column 2;
Point 6 in the lower center, row 3 column 2;
Point 7 in the upper right, row 1 column 3;
Point 8 in the middle right, row 2 column 3;
Point 9 in the lower right, row 3 column 3;
Point 10 above column 2, called the orientation point.

The orientation point will be ubiquitous for each color or shade.

The distances between the points of the matrix and their dimensions (FIG. 1, FIG. 2 and FIG. 3) are:

The minimum diameter of a point made with the help of the pointer: ˜1.5 mm
The distance between the points in columns: ˜2.3-˜2.54 mm
The distance between the points in rows: ˜2.3-˜2.54 mm
The minimum distance between two orientation points of two matrices lying horizontally: ˜11.1 mm
The minimum distance between two horizontal matrices: minimum ˜3.5 mm
The minimum distance between two matrices vertically, the distance between the base of the upper matrix and the orientation point of the lower matrix is: minimum ˜3.5 mm.

The colors represented in tactile language are: red, yellow, blue, orange, purple, green, brown and gray. The non-colors, black and white are also represented in this tactile language. Together with the aforementioned 8 colors, they are referred to as the Fundamental Group.

The light or dark shade of a color will be obtained by joining on the right side, horizontally, the matrix associated with the white color, if it is desired a light shade of the color, or joining on the right side, horizontally of the matrix associated with the black color in case you want a dark shade of the color, along with one of the 8 colors of the fundamental group (red, yellow, blue, green, orange, purple, brown and gray).

There is a graphic or tactile representation for 26 tactile-graphic signs, from which 8 represent basic colors (red, yellow, blue, orange, green, purple, brown and gray), 2 non-colors (white and black) and 16 shades (light red, dark red, light yellow, dark yellow, light blue, dark blue, light orange, dark orange, light green, dark green, light purple, dark purple, light brown, dark brown, light gray and dark gray).

### BRIEF DESCRIPTION OF THE DRAWINGS

The attached figures and drawings show, as illustrative examples, embodiments of the present invention:

FIG. 1 provides an illustration of the 10 points matrix, with numbered points

FIG. 2 illustrates the diameter of the point (two-dimensional) and the height of the relief determined by the Braille punch mark

FIG. 3 illustrates the distances between the points from the same matrix and the distance between the two matrices

FIG. 4 provides a representation of colors in the matrix which corresponds to the tactile representation (red, yellow, blue, orange, green, purple, brown, white, gray, black)

FIG. 5 provides a tactile—graphic representation of dark colors in the matrix which corresponds to the tactile representation (dark red, dark yellow, dark blue, dark orange, dark green, dark purple, dark brown, dark gray)

FIG. 6 provides a tactile—graphic representation of light colors in the matrix which corresponds to the tactile representation (light red, light yellow, light blue, light orange, light green, light purple, light brown, light gray)

### DETAILED DESCRIPTION OF THE INVENTION

An embodiment of the present invention includes, as illustrated in FIG. 1, the 10 points matrix, out of which 9 points are arranged on 3 columns plus the orientation point. The matrix can be read and recognized from left to right or right to left, bottom up or up bottom, with the following notation, (FIG. 1):

Point 1 on the top left, row 1, column 1;
Point 2 in the middle left, row two column 1;
Point 3 in the lower left, row 3 column 1;
Point 4 in the upper center, row 1 column 2;
Point 5 in the middle center, row 2 column 2;
Point 6 in the lower center, row 3 column 2;
Point 7 in the upper right, row 1 column 3;
Point 8 in the middle right, row 2 column 3;
Point 9 in the lower right, row 3 column 3;
Point 10 above column 2, called the orientation point.

The orientation point will be ubiquitous for each color or shade.

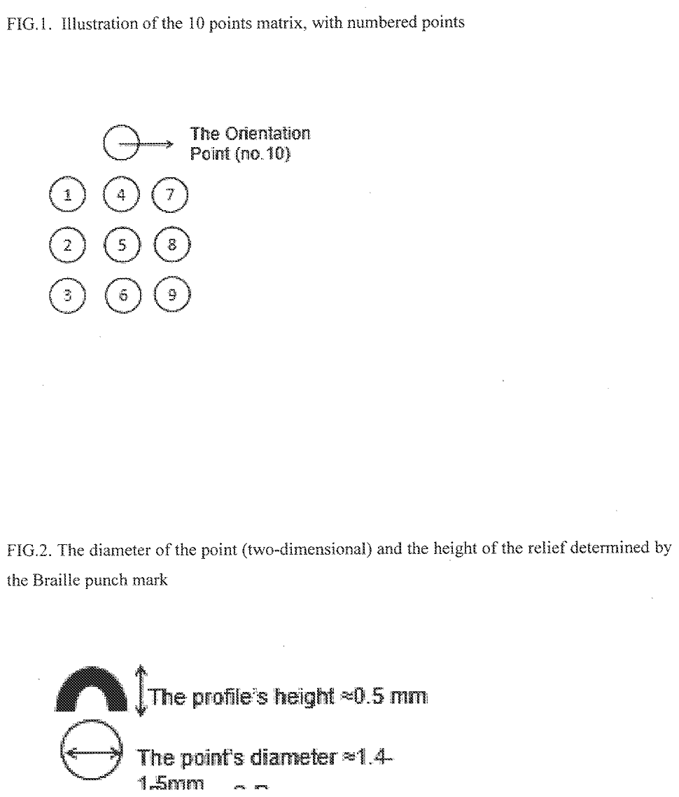

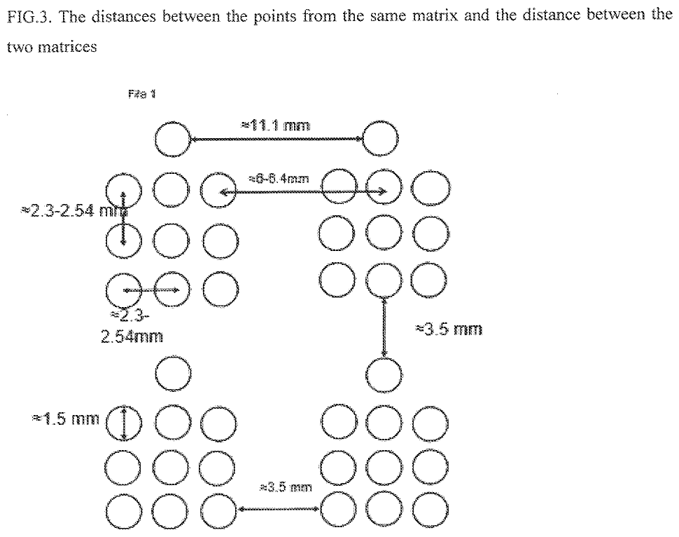

The distance between the points of the matrix and their dimensions (FIG. 1, FIG. 2 and FIG. 3) is:

The minimum diameter of a point made with the help of the punch mark: ˜1.5 mm
The distance between the points in columns: ˜2.3-˜2.54 mm
The distance between the points in rows: ˜2.3-˜2.54 mm
The minimum distance between two orientation points of two matrices lying horizontally: ˜11.1 mm
The minimum distance between two horizontal matrices: minimum ˜3.5 mm
The minimum distance between two matrices vertically, the distance between the base of the upper matrix and the orientation point of the lower matrix is: minimum ˜3.5 mm.

The colors represented in tactile language are: red, yellow, blue, orange, purple, green, brown and gray. The non-colors, black and white are also represented in tactile language. Together with the aforementioned 8 colors, they are referred to as the Fundamental Group.

The light or dark shade of a color will be obtained by joining on the right side, horizontally, the matrix associated with the white color, if it is desired alight shade of the color, or joining on the right side, horizontally of the matrix associated with the black color in case a dark shade of the color is desired, along with one of the 8 colors of the fundamental group (red, yellow, blue, green, orange, purple, brown and gray).

There is a graphic or tactile representation for 26 tactile-graphic signs, from which 8 represent basic colors (red, yellow, blue, orange, green, purple, brown and gray), 2 non-colors (white and black) and 16 shades (light red, dark red, light yellow, dark yellow, light blue, dark blue, light orange, dark orange, light green, dark green, light purple, dark purple, light brown, dark brown, light gray and dark gray).

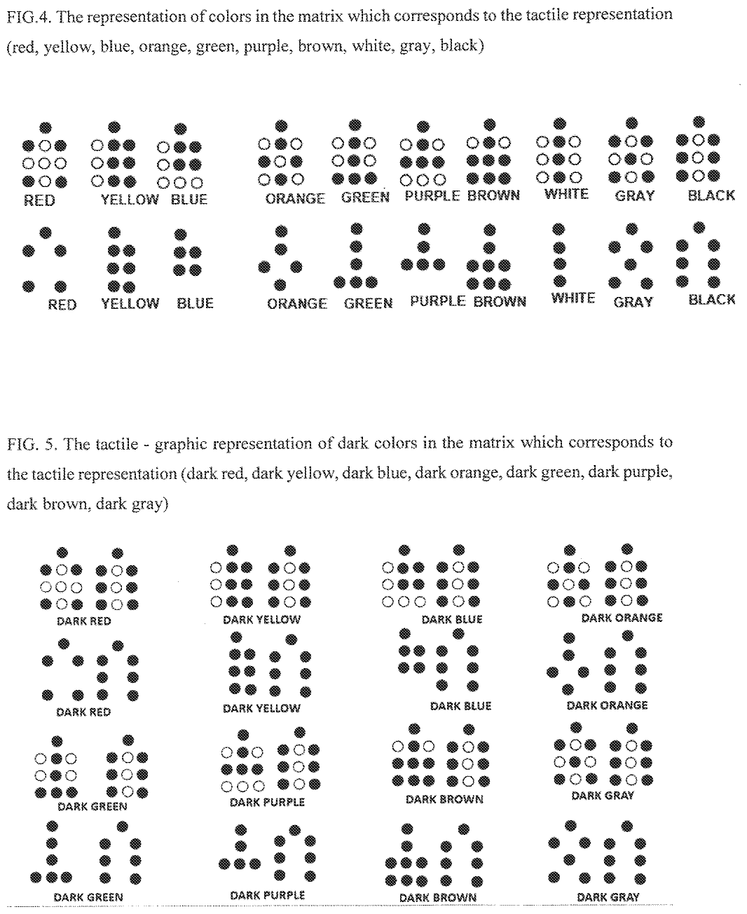

The RED color (FIG. 4) will be represented as follows:

Point 1 on the top left, row 1 column 1;
Point 3 in the lower left, row 3 column 1;
Point 7 in the upper right, row 1 column 3;
Point 9 in the lower right, row 3 column 3;
Point 10 above column 2, the orientation point;

The YELLOW color (FIG. 4) will be represented as follows:

Point 4 in the upper center, row 1 column 2;
Point 5 in the middle center, row 2 column 2;
Point 6 in the lower center, row 3 column 2;
Point 7 in the upper right, row 1 column 3;
Point 8 in the middle right, row 2 column 3;
Point 9 in the lower right, row 3 column 3;
Point 10 above column 2, the orientation point;

The BLUE color (FIG. 4) will be represented as follows:

Point 4 in the upper center, row 1 column 2;
Point 5 in the middle center, row 2 column 2;
Point 7 in the upper right, row 1 column 3;
Point 8 in the middle right, row 2 column 3;
Point 10 above column 2, the orientation point;

The ORANGE color (FIG. 4) will be represented as follows:

Point 4 in the upper center, row 1 column 2;
Point 2 in the middle left, row two column 1;
Point 6 in the lower center, row 3 column 2;
Point 8 in the middle right, row 2 column 3;
Point 10 above column 2, the orientation point;

The GREEN color (FIG. 4) will be represented as follows:

Point 4 in the upper center, row 1 column 2;
Point 5 in the middle center, row 2 column 2;
Point 6 in the lower center, row 3 column 2;
Point 3 in the lower left, row 3 column 1;
Item 9 in the lower right, row 3 column 3;
Point 10 above column 2, the orientation point;

The PURPLE color (FIG. 4) will be represented as follows:

Point 4 in the upper center, row 1 column 2;
Point 5 in the middle center, row 2 column 2;
Point 2 in the middle left, row two column 1;
Point 8 in the middle right, row 2 column 3;
Point 10 above column 2, the orientation point;

The BROWN color (FIG. 4) will be represented as follows:

Point 4 in the upper center, row 1 column 2;
Point 5 in the middle center, row 2 column 2;
Point 6 in the lower center, row 3 column 2;
Point 2 in the middle left, row 2 column 1;
Point 3 in the lower left, row 3 column 1;
Point 8 in the middle right, row 2 column 3;
Point 9 in the lower right, row 3 column 3;
Point 10 above column 2 called the orientation point;

The WHITE non-color (FIG. 4) will be represented as follows:

Point 4 in the upper center, row 1 column 2;
Point 5 in the middle center, row 2 column 2;
Point 6 in the lower center, row 3 column 2;
Point 10 above column 2 called the orientation point;

The GREY color (FIG. 4) will be represented as follows:

Point 1 on the top left, row 1 column 1;
Point 3 in the lower left, row 3 column 1;
Point 5 in the middle center, row 2 column 2
Point 7 in the upper right, row 1 column 3;
Point 9 in the lower right, row 3 column 3;
Point 10 above column 2, called the orientation point;

The BLACK non-color (FIG. 4) will be represented as follows:

Point 1 on the top left, row 1 column 1;
Point 2 in the middle left, row 2 column 1;
Point 3 in the lower left, row 3 column 1;
Point 7 in the upper right, row 1 column 3;
Point 8 in the middle right, row 2 column 3;
Point 9 in the lower right, row 3 column 3;
Point 10 above column 2 called the orientation point;

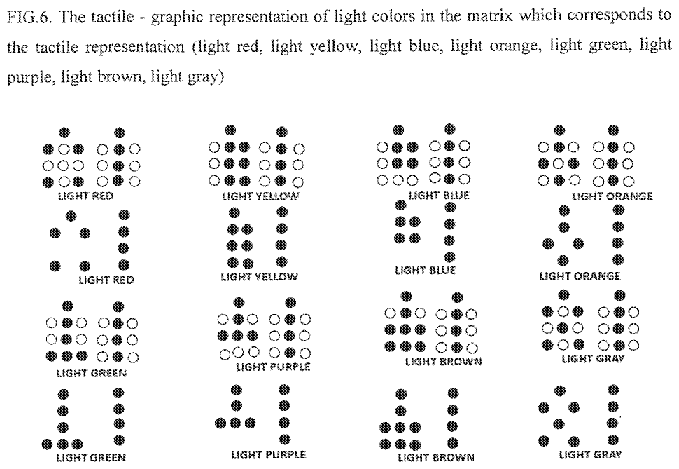

The light red color (FIG. 6) will be represented as follows:

Point 1 on the top left, row 1 column 1;
Point 3 in the lower left, row 3 column 1;
Point 7 in the upper right, row 1 column 3;
Point 9 in the lower right, row 3 column 3;
Point 10 above column 2, the orientation point, with the joining on the right side, horizontally of the matrix corresponding to the white non-color:
Point 4 in the upper center, row 1 column 2;
Point 5 in the middle center, row 2 column 2;
Point 6 in the lower center, row 3 column 2;
Point 10 above column 2, called the orientation point;

The light yellow color (FIG. 6) will be represented as follows:

Point 4 in the upper center, row 1 column 2;
Point 5 in the middle center, row 2 column 2;
Point 6 in the lower center, row 3 column 2;
Point 7 in the upper right, row 1 column 3;
Point 8 in the middle right, row 2 column 3;
Point 9 in the lower right, row 3 column 3,
Point 10 above column 2, the orientation point, with the joining on the right side, horizontally of the matrix corresponding to the white non-color:
Point 4 in the upper center, row 1 column 2;
Point 5 in the middle center, row 2 column 2;
Point 6 in the lower center, row 3 column 2;
Point 10 above column 2, called the orientation point;

The light blue color (FIG. 6) will be represented as follows:

Point 4 in the upper center, row 1 column 2;
Point 5 in the middle center, row 2 column 2;
Point 7 in the upper right, row 1 column 3;
Point 8 in the middle right, row 2 column 3;
Point 10 above column 2, the orientation point, with the joining on the right side, horizontally, of the matrix corresponding to the white non-color:
Point 4 in the upper center, row 1 column 2;
Point 5 in the middle center, row 2 column 2;
Point 6 in the lower center, row 3 column 2;
Point 10 above column 2, called the orientation point;

The light orange (FIG. 6) will be represented as follows:

Point 4 in the upper center, row 1 column 2;
Point 2 in the middle left, row two column 1;
Point 6 in the lower center, row 3 column 2;
Point 8 in the middle right, row 2 column 3;
Point 10 above column 2, the orientation point, with the joining on the right side, horizontally of the matrix corresponding to the white non-color:
Point 4 in the upper center, row 1 column 2;
Point 5 in the middle center, row 2 column 2;
Point 6 in the lower center, row 3 column 2;
Point 10 above column 2 called the orientation point;

The light green (FIG. 6) will be represented as follows:

Point 4 in the upper center, row 1 column 2;
Point 5 in the middle center, row 2 column 2;
Point 6 in the lower center, row 3 column 2;
Point 3 in the lower left, row 3 column 1;
Point 9 in the lower right, row 3 column 3;
Point 10 above column 2, the orientation point, with the joining on the right side, horizontally of the matrix corresponding to the white non-color:
Point 4 in the upper center, row 1 column 2;
Point 5 in the middle center, row 2 column 2;
Point 6 in the lower center, row 3 column 2;
Point 10 above column 2 called the orientation point;

The light purple (FIG. 6) will be represented as follows:

Point 4 in the upper center, row 1 column 2;
Point 5 in the middle center, row 2 column 2;
Point 2 in the middle left, row 2 column 1;
Point 8 in the middle right, row 2 column 3;
Point 10 above column 2, the orientation point, with the joining on the right side, horizontally of the matrix corresponding to the white non-color:
Point 4 in the upper center, row 1 column 2;
Point 5 in the middle center, row 2 column 2;
Point 6 in the lower center, row 3 column 2;
Point 10 above column 2 called the orientation point;

The light brown (FIG. 6) will be represented as follows:

Point 4 in the upper center, row 1 column 2;
Point 5 in the middle center, row 2 column 2;
Point 6 in the lower center, row 3 column 2;
Point 2 in the middle left, row two column 1;
Point 3 in the lower left, row 3 column 1;
Point 8 in the middle right, row 2 column 3;
Point 9 in the lower right, row 3 column 3;
Point 10 above column 2, the orientation point, with the joining on the right side, horizontally, of the matrix corresponding to the white non-color:
Point 4 in the upper center, row 1 column 2;
Point 5 in the middle center, row 2 column 2;
Point 6 in the lower center, row 3 column 2;
Point 10 above column 2 called the orientation point;

The light gray (FIG. 6) will be represented as follows:

Point 1 on the top left, row 1 column 1;
Point 3 in the lower left, row 3 column 1;
Point 5 in the middle center, row 2 column 2
Point 7 in the upper right, row 1 column 3;
Point 9 in the lower right, row 3 column 3;
Point 10 above column 2, the orientation point, with the joining on the right side, horizontally, of the matrix corresponding to the white non-color:
Point 4 in the upper center, row 1 column 2;
Point 5 in the middle center, row 2 column 2;
Point 6 in the lower center, row 3 column 2;
Point 10 above column 2, called the orientation point;

The dark red (FIG. 5) will be represented as follows:

Point 1 on the top left, row 1 column 1;
Point 3 in the lower left, row 3 column 1;
Point 7 in the upper right, row 1 column 3;
Point 9 in the lower right, row 3 column 3;
Point 10 above column 2, the orientation point, with the joining on the right side, horizontally, of the matrix corresponding to the black non-color:
Point 1 on the top left, row 1 column 1;
Point 2 in the middle left, row 2 column 1;
Point 3 in the lower left, row 3 column 1;
Point 7 in the upper right, row 1 column 3;
Point 8 in the middle right, row 2 column 3;
Point 9 in the lower right, row 3 column 3;
Point 10 above column 2, called the orientation point;

The dark yellow (FIG. 5) will be represented as follows:

Point 4 in the upper center, row 1 column 2;
Point 5 in the middle center, row 2 column 2;
Point 6 in the lower center, row 3 column 2;
Point 7 in the upper right, row 1 column 3;
Point 8 in the middle right, row 2 column 3;
Point 9 in the lower right, row 3 column 3,
Point 10 above column 2, the orientation point with the joining on the right side, horizontally, of the matrix corresponding to the black non-color:
Point 1 on the top left, row 1 column 1;
Point 2 in the middle left, row 2 column 1;
Point 3 in the lower left, row 3 column 1;
Point 7 in the upper right, row 1 column 3;
Point 8 in the middle right, row 2 column 3;
Point 9 in the lower right, row 3 column 3;
Point 10 above column 2 called the orientation point;

The dark blue (FIG. 5) will be represented as follows:

Point 4 in the upper center, row 1 column 2;
Point 5 in the middle center, row 2 column 2;
Point 7 in the upper right, row 1 column 3;
Point 8 in the middle right, row 2 column 3;
Point 10 above column 2, the orientation point, with the joining on the right side, horizontally, of the matrix corresponding to the black non-color:
Point 1 on the top left, row 1 column 1;
Point 2 in the middle left, row 2 column 1;
Point 3 in the lower left, row 3 column 1;
Point 7 in the upper right, row 1 column 3;
Point 8 in the middle right, row 2 column 3;
Point 9 in the lower right, row 3 column 3;
Point 10 above column 2, called the orientation point;

The dark orange (FIG. 5) will be represented as follows:

Point 4 in the upper center, row 1 column 2;
Point 2 in the middle left, row two column 1;
Point 6 in the lower center, row 3 column 2;
Point 8 in the middle right, row 2 column 3;
Point 10 above column 2, the orientation point, with the joining on the right side, horizontally, of the matrix corresponding to the black non-color:
Point 1 on the top left, row 1 column 1;
Point 2 in the middle left, row 2 column 1;
Point 3 in the lower left, row 3 column 1;
Point 7 in the upper right, row 1 column 3;
Point 8 in the middle right, row 2 column 3;
Point 9 in the lower right, row 3 column 3;
Point 10 above column 2 called the orientation point;

The dark green (FIG. 5) will be represented as follows:

Point 4 in the upper center, row 1 column 2;
Point 5 in the middle center, row 2 column 2;
Point 6 in the lower center, row 3 column 2;
Point 3 in the lower left, row 3 column 1;
Point 9 in the lower right, row 3 column 3;
Point 10 above column 2, the orientation point, with the joining on the right side, horizontally, of the matrix corresponding to the black non-color:
Point 1 on the top left, row 1 column 1;
Point 2 in the middle left, row 2 column 1;
Point 3 in the lower left, row 3 column 1;
Point 7 in the upper right, row 1 column 3;
Point 8 in the middle right, row 2 column 3;
Point 9 in the lower right, row 3 column 3;
Point 10 above column 2, called the orientation point;

The dark purple (FIG. 5) will be represented as follows:

Point 4 in the upper center, row 1 column 2;
Point 5 in the middle center, row 2 column 2;
Point 2 in the middle left, row two column 1;
Point 8 in the middle right, row 2 column 3;
Point 10 above column 2, the orientation point, with the joining on the right side, horizontally, of the matrix corresponding to the black non-color:
Point 1 on the top left, row 1 column 1;
Point 2 in the middle left, row 2 column 1;
Point 3 in the lower left, row 3 column 1;
Point 7 in the upper right, row 1 column 3;
Point 8 in the middle right, row 2 column 3;
Point 9 in the lower right, row 3 column 3;
Point 10 above column 2, called the orientation point;

The dark brown (FIG. 5) will be represented as follows:

Point 4 in the upper center, row 1 column 2;
Point 5 in the middle center, row 2 column 2;
Point 6 in the lower center, row 3 column 2;
Point 2 in the middle left, row two column 1;
Point 3 in the lower left, row 3 column 1;
Point 8 in the middle right, row 2 column 3;
Point 9 in the lower right, row 3 column 3;
Point 10 above column 2, the orientation point, with the joining on the right side, horizontally, of the matrix corresponding to the black non-color:
Point 1 on the top left, row 1 column 1;
Point 2 in the middle left, row 2 column 1;
Point 3 in the lower left, row 3 column 1;
Point 7 in the upper right, row 1 column 3;
Point 8 in the middle right, row 2 column 3;
Point 9 in the lower right, row 3 column 3;
Point 10 above column 2, called the orientation point;

The dark gray (FIG. 5) will be represented as follows:

Point 1 on the top left, row 1 column 1;
Point 3 in the lower left, row 3 column 1;
Point 5 in the middle center, row 2 column 2
Point 7 in the upper right, row 1 column 3;
Point 9 in the lower right, row 3 column 3;
Point 10 above column 2, the orientation point, with the joining on the right side, horizontally of the matrix corresponding to the black non-color:
Point 1 on the top left, row 1 column 1;
Point 2 in the middle left, row 2 column 1;
Point 3 in the lower left, row 3 column 1;
Point 7 in the upper right, row 1 column 3;
Point 8 in the middle right, row 2 column 3;
Point 9 in the lower right, row 3 column 3;
Point 10 above column 2 called the orientation point;

A further embodiment is the solution of tactile-graphic representation of a color only by a symbol. From the point of view of technical utility, this method helps the tactile recognition of the colors and facilitates the accessibility of the environment.

By using this method, visually impaired children or adults can learn colors through tactile representation, without having to know the Braille Alphabet. The symbols can be used in children's books, on toys, for color recognition. An important example is the application of the symbols for each color on the LEGO game, so that a blind child with partially affected eyesight can build a game based on tactile representation and color recognition. Education can be achieved through a very wide range of educational objects, games, coloring books, art albums, coloring/painting tools.

The use of these symbols will also help to increase the quality of life of the visually impaired in the cities by applying the red and green symbols to the pedestrian crossings. These symbols can also be used in the textile industry, by applying the symbols created on clothing or clothing labels. The development of software and hardware programs and equipment for accessibility, therapy and recovery for people with visual or intellectual disabilities are other consequences deriving from this method.

Accessibility of the environment with the help of access technologies and related equipment: devices and tools for learning this alphabet, printers, scanners, etc.

Transposition of the great masterpieces of museums in this tactile language of color understanding and accessibility of museums with the equipment and access technologies adapted to this method.

The invention is not limited to the details of the foregoing illustrated embodiments and the present invention may be embodied in other specific forms without departing from the spirit or essential attributes thereof. The present embodiments are therefore to be considered in all respects as illustrative—and not restrictive—the scope of the invention being indicated by the appended claims rather than by the foregoing description, and all changes which come within the meaning and range of equivalency of the claims are therefore intended to be embraced therein. As stated above, the novelty elements are given by the introduction of a single 10 points matrix, the way of placing the points and the associations for the colors and for the shades of colors.

It should be emphasized that the described embodiments are possible examples of implementations, merely set forth for a clear understanding of the principles. Variations and modifications may be made to the described embodiment(s) without substantially departing from the spirit and principles of the present teaching. All such modifications are intended to be included herein within the scope of this disclosure and the present invention and protected by the following claims. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A method of color representation for the visually impaired and blind people characterized by using a matrix consisting of 10 points of which 9 points are arranged on three columns of three points with one orientation point located above the second column and which can be read and recognized from left to right, vice versa, bottom up and vice versa.

2. The method of colors representation according to claim 1, characterized that the colors red, yellow, blue, green, orange, purple, brown, gray and non-colors black and white are represented by a single symbol.

3. The method of representation according to claim 1, characterized that the light or dark color shade of a color is obtained by joining on the horizontal right side, the matrix associated with the white color, if the light shade of the color is desired, respectively joining on the horizontal right side the matrix associated with the black color, if the dark shade of the color is desired, along with one of the following colors: red, yellow, blue, green, orange, purple, brown, gray.

4. The method of representation according to claim 1, characterized that the color recognition can be done in any position, including in a painting, due to the orientation point contained in the matrix.

5. The method of representation according to claim 1 further comprising the possibility to be used in the fashion industry, textile industry, toy manufacturing and software applications.
